(19) United States
(12) Patent Application Publication
(10) Pub. No.: US 2026/0212866 A1
(43) Pub. Date: Jul. 23, 2026

(54) CONVERSATION RESPONSE SYSTEM, CONVERSATION RESPONSE METHOD, AND NON-TRANSITORY RECORDING MEDIUM

(71) Applicant: Hitachi, Ltd., Tokyo (JP)

(72) Inventors: Hidenori SAKANIWA, Tokyo (JP); Shintaro SUZUKI, Tokyo (JP); Akihiko HYODO, Tokyo (JP)

(21) Appl. No.: 19/455,477

(22) Filed: Jan. 21, 2026

(30) Foreign Application Priority Data
Jan. 23, 2025 (JP) 2025-009653

(51) Int. Cl. G10L 15/22; G06F 16/3329

(52) U.S. Cl. CPC G10L 15/22; G06F 16/33295

(57) ABSTRACT

A conversation response system: executes conversation with a user by using a language model; estimate a request of the user based on the conversation; extracts a response function corresponding to a past response history; aggregates a distribution of evaluations in the response function by users: calculates a request matching degree to which the response function matches the estimated request based on an aggregate result of the distribution; obtains and outputs a question about whether the request of the user is satisfied by the response function: obtains an answer by the user to the question: and determine a function satisfying the request of the user based on an evaluation of the obtained answer.

### CLAIM OF PRIORITY

The present application claims priority from Japanese patent application JP 2025-009653 filed on Jan. 23, 2025, the content of which is hereby incorporated by reference into this application.

### BACKGROUND OF THE INVENTION

The present invention relates to a conversation response system, a conversation response method, and a non-transitory recording medium.

As a background art of the present technical field, there is JP 2024-1127 A. This publication describes that “the method generates an agent request based on a natural language input instance, selects a set of a plurality of agents from a corpus of available agents for the agent request, transmits the agent request to each of the plurality of agents, receives a corresponding response to the agent request from each of the plurality of agents, stores an association of the agent request with the response to the agent request in a computer-readable recording medium, generates an agent selection model based on the stored association, receives a subsequent natural language input of a user, selects a particular agent based on the subsequent natural language input and the agent selection model, and transmits the call request to the selected particular agent.” (see Abstract).

### SUMMARY OF THE INVENTION

The technique described in JP 2024-1127 A selects an agent in accordance with a request of a user, but JP 2024-1127 A does not disclose that a user is asked a question for specifying a user's request and a function that satisfies the user's request with higher accuracy. Therefore, an aspect of the present invention specifies a function that satisfies a user's request with higher accuracy.

The aspect of the present invention adopts the following structures in order to solve the above problems. A conversation response system includes: a processor; a memory; an input device; and an output device, the conversation response system is connected to a language model, the memory is configured to hold: function information indicating a function that can be provided by the conversation response system; and response history information indicating a request of a user indicated by a history of a past conversation between the conversation response system and the user, a response function which is the function provided in the conversation, and evaluation by the user for a response including the conversation and provision of the response function, and the processor is configured to: execute a conversation with the user by generating a first prompt including an instruction to generate a response to an utterance of the user acquired via the input device, inputting the first prompt to the language model, and outputting a response output from the language model based on the input to the output device; summarize the conversation to estimate the request of the user; aggregate a distribution of corresponding evaluations in the response history information with respect to the response function included in the response history information; calculate a request matching degree indicating a degree of satisfaction of the estimated request by the response function included in the response history information based on an aggregation result of the distribution; execute request-related question processing for the response function included in the response history information in descending order of the evaluation indicated by the request matching degree; in the request-related question processing, generate a second prompt including an instruction to generate a question about whether the request of the user is satisfied by the response function; input the second prompt to the language model; output, from the output device, a question output from the language model based on the input; and determine the response function as a function that satisfies a request of the user and terminate the request-related question processing, when an answer to the question is obtained from the user via the input device and an evaluation of the obtained answer is a predetermined value or more.

The aspect of the present invention can specify a function that satisfies a user's request with higher accuracy

Problems, configurations, and effects which are not mentioned above are explained in the following embodiments.

### BRIEF DESCRIPTIONS OF DRAWINGS

The present invention can be appreciated by the description which follows in conjunction with the following figures, wherein:

FIG. 1 is a block diagram illustrating a functional configuration example of a conversation response system according to the first embodiment;

FIG. 2 is a block diagram illustrating a functional configuration example of an agent according to the first embodiment;

FIG. 3 is a block diagram illustrating a hardware configuration example of a computer according to the first embodiment;

FIG. 4 is a diagram illustrating a data configuration example of a function list table according to the first embodiment;

FIG. 5 is a diagram illustrating a data configuration example of a function evaluation table according to the first embodiment;

FIG. 6 a diagram illustrating a data configuration example of status information is according to the first embodiment;

FIG. 7 is a diagram illustrating a data configuration example of response history information according to the first embodiment;

FIG. 8 is a diagram illustrating a data configuration example of conversation history information according to the first embodiment;

FIG. 9 is a diagram illustrating a data configuration example of an assumed request sentence dictionary according to the first embodiment;

FIG. 10 a sequence diagram illustrating an example of conversation response processing is according to the first embodiment;

FIG. 11 is a flowchart illustrating an example of request check processing according to the first embodiment;

FIG. 12 is an explanatory diagram illustrating an example of similarity calculation processing, response extraction processing, and evaluation aggregation processing according to the first embodiment;

FIG. 13 is a diagram illustrating a data configuration example of a request matching degree table according to the first embodiment;

FIG. 14 is a flowchart illustrating an example of request-related question processing according to the first embodiment;

FIG. 15 is a flowchart illustrating an example of agent selection processing according to the first embodiment;

FIG. 16 is a flowchart illustrating an example of agent selection processing according to the second embodiment; and

FIG. 17 is a diagram illustrating a data configuration example of the conversation history information according to the third embodiment.

### DESCRIPTION OF THE PREFERRED EMBODIMENTS

In the following, embodiments of the present invention are explained referring the attached drawings. In the embodiments, the same configuration has the same reference letter. The embodiments are examples to achieve the present invention and do not limit a technical range of the present invention.

### First Embodiment

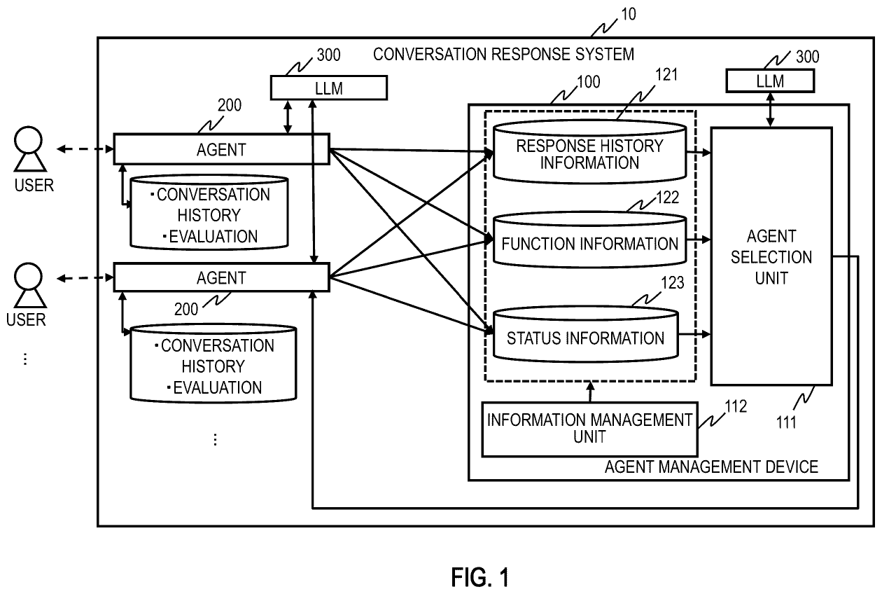

FIG. 1 is a block diagram illustrating a functional configuration example of a conversation response system 10. The conversation response system 10 includes, for example, an agent management device 100 and a plurality of agents 200 connected to each other via a network such as the Internet or an intranet.

Each of the agents 200 is an individual capable of performing autonomous behavior, such as a robot or a signage, and enables a conversation with the user using a large language model (LLM) 300 which is an example of a language model. That is, the agent 200 acquires an utterance from the user, inputs the utterance to the LLM 300, thereby acquiring a conversation as a response to the utterance, and outputs the acquired conversation, thereby realizing a conversation with the user.

Note that the agent 200 may use a cloud type LLM 300 included in an external cloud server or the like, or may use a local type LLM 300 held by the agent 200 itself. The agent 200 holds a conversation history with the user and information indicating evaluation from the user for response of the agent 200 to the user including the conversation.

The agent management device 100 includes, for example, an agent selection unit 111 and an information management unit 112 which are both functional units. The agent management device 100 holds, for example, response history information 121, function information 122, and status information 123.

The response history information 121 indicates a history in which each agent 200 has responded to the user by conversation with the user. The response history includes, for example, a summary of a conversation and information indicating evaluation from the user for response of the agent 200 to the user including the conversation. The function information 122 indicates a function of each agent 200. The status information 123 indicates a status indicating whether each agent 200 can respond to the user and a status such as a position of the agent 200.

The information management unit 112 updates the response history information 121, the function information 122, and the status information 123 in accordance with various information received from the agent 200. The information management unit 112 transmits the response history information 121 to each agent, and the agent 200 estimates a request of the user from a conversation with the user currently being held based on the response history information 121, and notifies the agent management device 100 of the estimated request.

The agent selection unit 111 selects the agent 200 capable of satisfying the estimated request as the takeover destination agent 200 of the conversation based on the function information 122 and the status information 123, and notifies the agent 200 currently having a conversation and the selected agent 200 of information indicating the selection result.

The agent 200 currently having a conversation performs conversation takeover to the takeover destination agent 200, so that the response to the user is taken over to the takeover destination agent 200.

The agent management device 100 may generate a question to the user using the LLM 300. Note that the agent management device 100 may use a cloud type LLM 300 included in an external cloud server or the like, or may use a local type LLM 300 held by the agent 200 itself. Note that the agent management device 100 and the agent 200 may use the same LLM 300, or may use different LLMs 300.

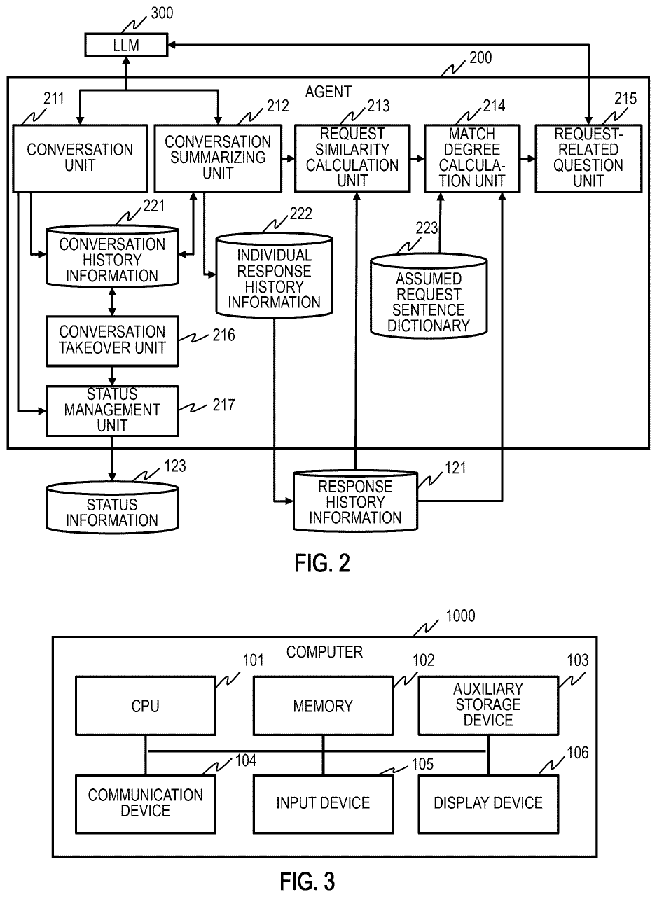

FIG. 2 is a block diagram illustrating a functional configuration example of the agent 200. The agent 200 includes, for example, a conversation unit 211, a conversation summarizing unit 212, a request similarity calculation unit 213, a match degree calculation unit 214, a request-related question unit 215, a conversation takeover unit 216, and a status management unit 217, all of which are functional units. Furthermore, the agent 200 holds, for example, conversation history information 221, individual response history information 222, and an assumed request sentence dictionary 223.

The conversation history information 221 holds information indicating a conversation history by the conversation unit 211. The individual response history information 222 indicates a history in which the agent 200 has responded to the user by conversation with the user. The assumed request sentence dictionary 223 indicates a sentence (hereinafter, also referred to as an assumed request sentence) assumed as an utterance from the user when the user requests provision of the function (for example, it includes a physical function realized by driving a drive mechanism of the agent 200, such as screen display, autonomous traveling, and pointing, and a specific task automatically executed by a pre-designed software program held by the agent 200) of at least one agent 200 included in the conversation response system 10.

The conversation unit 211 acquires utterance from the user via a microphone or the like included in the agent 200, and converts the acquired utterance into text using a predetermined speech recognition algorithm. The conversation unit 211 generates a prompt including the text and an instruction to generate a response to the utterance indicated by the text, and acquires the response to the utterance from the LLM 300 by inputting the prompt to the LLM 300. The conversation unit 211 outputs the acquired response from a speaker or the like provided in the agent 200.

The conversation unit 211 stores a conversation history including the utterance from the user and the response to the user, and a start time, an end time, and a time from the start time to the end time of the conversation in the conversation history information 221.

Furthermore, the conversation unit 211 controls the operation of the physical configurations (for example, the robot arm, the signage display, or the like) of the agent 200 in response to the response, thereby providing the function of the components. Furthermore, the conversation unit 211 provides a function by the above-described specific task associated with the response by executing a pre-designed software program held by the agent 200. Note that the conversation unit 211 further includes, for example, a list of functions (for example, the information indicating the list is stored in advance in the agent 200) that the conversation unit holds in the LLM 300 and an instruction to generate information indicating the content of provision of the function in the response to the utterance in the above prompt, thereby acquiring an instruction regarding provision of the function (operation of physical configuration and/or execution of software program) according to the response content from the LLM 300. Furthermore, for example, the conversation unit 211 may determine and control provision of a function associated with the response content by itself from the response content acquired from the LLM 300.

The conversation summarizing unit 212 generates a prompt including a conversation history and an instruction to generate a summary of a conversation indicated by the conversation history, and inputs the prompt to the LLM 300 to acquire the summary of the conversation from the LLM 300. Note that the instruction to generate the summary of the conversation includes an instruction to estimate the request of the user from the conversation.

Furthermore, the conversation summarizing unit 212 acquires the evaluation for the user from the LLM 300 by including, in the prompt, an instruction to calculate the evaluation from the user for the response (including a conversation and an operation by a physical function) of the agent 200 to the user including the conversation based on the utterance content of the user in the conversation history. For example, in a case where the user makes an utterance or an affirmative utterance indicating gratitude such as “thank you”, a high evaluation is output, and in a case where the user makes a negative utterance or the like such as “I did not request such a thing”, a low evaluation is output. Note that the user may directly input the evaluation via the input device included in the agent 200, or the administrator of the agent 200 may directly input the evaluation via the input device after visually confirming the conversation history.

The conversation summarizing unit 212 stores the summary of the conversation in the conversation history information 221. The conversation summarizing unit 212 stores the estimated request of the user, the function of the agent 200 provided along with the response in the conversation, and the calculated evaluation in the individual response history information 222. The information stored in the individual response history information 222 is transmitted to the agent management device 100, whereby the response history information 121 indicating the individual response history information 222 of all the agents 200 included in the conversation response system 10 is generated.

Furthermore, the conversation summarizing unit 212 also generates a summary of the conversation currently being held by the conversation unit 211 in real time, and outputs the summary to the request similarity calculation unit 213. The request similarity calculation unit 213 calculates similarity (for example, cosine similarity between requests converted into a vector indicating a meaning by a predetermined algorithm, or the like) between the request indicated by the summary of the conversation currently being held and each request indicated by the response history information 121 transmitted from the agent management device 100, and outputs the similarity to the match degree calculation unit 214.

Based on the similarity, the evaluation indicated by the response history information 121, and the assumed request sentence indicated by the assumed request sentence dictionary 223, the match degree calculation unit 214 calculates a request matching degree for evaluating a degree of satisfying the request estimated by the function provided by the agent 200 indicated by the response history information 121, and outputs the request matching degree to the request-related question unit 215.

The request-related question unit 215 acquires a request-related question by inputting, to the LLM 300, a prompt including information indicating a function with a high request matching degree and an instruction to generate a request-related question that is a question regarding whether the user's request is satisfied by the function. The conversation unit 211 outputs the request-related question from a speaker or the like, and acquires an answer from the user to the request-related question from a microphone or the like.

The request-related question unit 215 acquires the evaluation from the LLM 300 by inputting, to the LLM 300, a prompt including the answer from the user and an instruction to calculate, based on the answer, the evaluation from the user for the function indicated by the request-related question. The request-related question unit 215 determines a function matching the user's request based on the acquired evaluation, and notifies the agent management device 100 of the determined function.

When taking over the response of the user to another agent 200, the conversation takeover unit 216 refers to the conversation history information 221 and hands over the conversation with the user to another agent 200. When the conversation unit 211 recognizes the start and end of the conversation with the user, when the conversation takeover unit 216 hands over the conversation to another agent 200, or the like, the status management unit 217 updates the status and notifies the agent management device 100 of the updated status.

In addition, the status management unit 217 notifies the agent management device 100 of the position of the agent 200, for example, periodically. Further, when the response is in progress or the response preparation is in progress for the user, the status management unit 217 calculates a prediction time (hereinafter, also referred to as a response completion prediction time) until the response or the response in preparation is completed, and notifies the agent management device 100 of the prediction time. The status information 123 of the agent management device 100 is updated according to the notification content from the status management unit 217.

Note that a part (for example, the request similarity calculation unit 213, the match degree calculation unit 214, and the request-related question unit 215) of the functional unit of the agent 200 may be included in the agent management device 100. In this case, processing by the functional unit is executed by the agent management device 100, and communication between the agent 200 and the agent management device 100 associated with the processing is omitted.

FIG. 3 is a block diagram illustrating a hardware configuration example of the computer 1000. The agent management device 100 includes, for example, a computer 1000. Each of the agents 200 includes a configuration as the computer 1000 and a physical configuration related to autonomous behavior. For example, in addition to the configuration as the computer 1000, the agent 200 which is a robot includes wheels for autonomous traveling, a carriage for conveying a human or an object, an arm for pointing, and the like, and a drive mechanism for operating these. Furthermore, for example, the agent 200 that is signage includes a display or the like for displaying an image in addition to the configuration as the computer 1000. Furthermore, the agent 200 may include a device that measures its own position.

The computer 1000 includes, for example, a central processing unit (CPU) 101, a memory 102, an auxiliary storage device 103, a communication device 104, an input device 105, and an output device 106.

The CPU 101 is an example of a processor, and executes a program stored in the memory 102. The memory 102 includes a read only memory (ROM) that is a nonvolatile storage element and a random access memory (RAM) that is a volatile storage element. The ROM stores an invariable program (for example, basic input/output system (BIOS)) and the like. The RAM is a high-speed and volatile storage element such as a dynamic random access memory (DRAM), and temporarily stores a program executed by the CPU 101 and data used when the program is executed.

The auxiliary storage device 103 is, for example, a large-capacity and nonvolatile storage device such as a magnetic storage device (hard disk drive (HDD)) or a flash memory (solid state drive (SSD)), and stores a program executed by the CPU 101 and data used when the program is executed. That is, the program is read from the auxiliary storage device 103, loaded into the memory 102, and executed by the CPU 101.

The communication device 104 is a network interface device that controls communication with other devices according to a predetermined protocol. Furthermore, the communication device 104 includes, for example, a serial interface such as a universal serial bus (USB).

The input device 105 is a device that receives an input from an operator. The input device 105 of the computer 1000 constituting the agent management device 100 includes, for example, a keyboard, a mouse, and the like. The input device 105 of the computer 1000 constituting the agent 200 includes, for example, a microphone or the like for acquiring the utterance from the user. Note that the utterance from the user may be acquired not only from the microphone or the like but also from a keyboard, a touch panel, or the like. In a case where an utterance from the user is acquired by the keyboard, the touch panel, or the like, the utterance from the user may be acquired not only by character input but also by drawing input or the like.

The output device 106 is a device that outputs the execution result of the program in a format that can be visually recognized by the operator. The output device 106 of the computer 1000 constituting the agent management device 100 includes, for example, a display device, a printer, and the like. The output device 106 of the computer 1000 constituting the agent 200 includes, for example, a speaker or the like that outputs the utterance to the user. Note that the utterance to the user is not limited to the speaker or the like, and may be output from a display device or the like. In a case where the display device outputs the utterance to the user, the utterance to the user may be expressed not only by character information but also by an image such as a picture.

A part or all of the program executed by the CPU 101 may be provided from a removable medium (CD-ROM, flash memory, or the like) that is a non-transitory storage medium or an external computer including a non-transitory storage device to the computer 1000 via a network, and may be stored in the non-volatile auxiliary storage device 103 that is a non-transitory storage medium. Therefore, the computer 1000 preferably has an interface for reading data from the removable medium.

Each of the agent management device 100 and the agent 200 is a computer system configured on physically one computer 1000 or a plurality of computers 1000 configured logically or physically, and may operate on separate threads on the same computer 1000 or may operate on a virtual computer constructed on a plurality of physical computer resources.

The CPU 101 of the computer 1000 constituting the agent management device 100 includes, for example, a functional unit included in the agent management device 100 described above. For example, the CPU 101 of the computer 1000 constituting the agent management device 100 functions as the agent selection unit 111 by operating according to the agent selection program loaded in the memory 102 of the computer 1000 constituting the agent management device 100, and functions as the information management unit 112 by operating according to the information management program loaded in the memory 102 of the computer 1000 constituting the agent management device 100. The relationship among the CPU 101, the program, and the functional unit is the same for the functional unit included in the agent 200.

Note that a part or all of the functions of the functional units included in the agent management device 100 and a part or all of the functions of the functional units included in the agent 200 may be realized by hardware such as an application specific integrated circuit (ASIC) or a field-programmable gate array (FPGA), for example.

The auxiliary storage device 103 of the computer 1000 constituting the agent management device 100 holds the response history information 121, the function information 122, and the status information 123 described above. The auxiliary storage device 103 of the computer 1000 constituting the agent 200 holds the individual response history information 222 and the assumed request sentence dictionary 223 described above.

Note that some or all of the information included in the agent management device 100 may be stored in the memory 102 of the computer 1000 constituting the agent management device 100 or may be stored in an external database connected to the agent management device 100. The same applies to the agent 200.

Note that, in the present exemplary embodiment, the information used by the conversation response system 10 may be expressed by any data structure without depending on the data structure. For example, an appropriately selected data structure from a table, list, database, or queue may store the information.

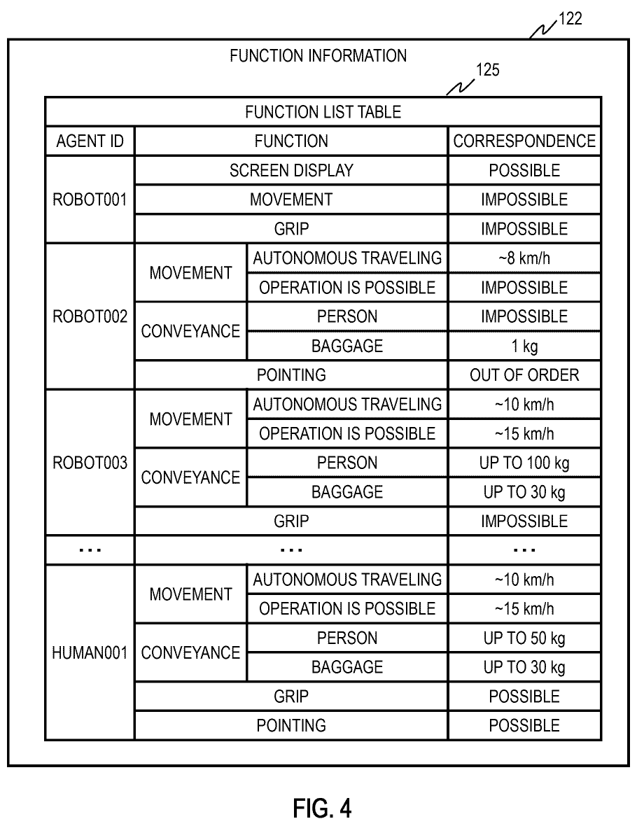

FIG. 4 is a diagram illustrating a data configuration example of a function list table 125. The function list table 125 is included in the function information 122. The function list table 125 indicates a function by a physical configuration of the agent 200 for each agent ID for identifying each agent 200. The function list table 125 is registered in advance in the agent management device 100.

As illustrated in the example of FIG. 4, the function list table 125 may include values indicating the feasibility of the function, such as “possible” and “impossible”, or may include values indicating conditional feasibility, such as “autonomous traveling” of “up to 8 km/h” is possible.

Furthermore, as indicated by an agent ID “HUMAN001” in the example of FIG. 4, the conversation response system 10 may include the agent 200 that is a human. In a case where the agent 200 is a human, the function list table 125 indicates the physical performance of the human. Note that, in a case where the agent 200 is a human, for example, the human holds a terminal such as a tablet, a smartphone, or a personal computer (PC) including a microphone, a speaker, and the like, and the terminal holds the above-described functional unit and information, whereby processing by the above-described functional unit is realized.

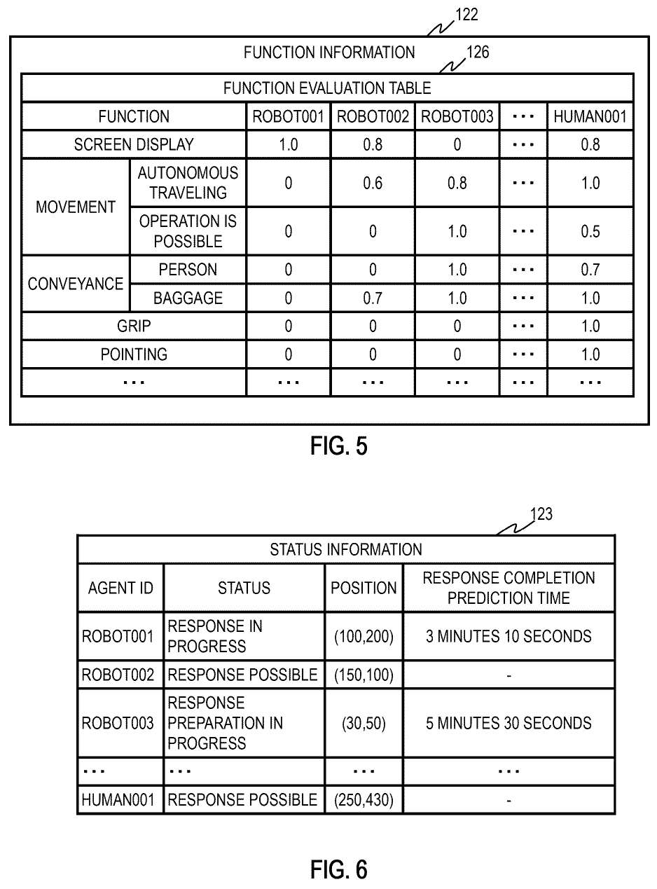

FIG. 5 is a diagram illustrating a data configuration example of the function evaluation table 126. The function evaluation table 126 is included in the function information 122. The function evaluation table 126 may be generated by the information management unit 112 based on the function list table 125 or may be registered in advance in the agent management device 100.

The function evaluation table 126 holds, for each agent ID, evaluation obtained by quantifying the capability of the function according to the physical configuration of the agent 200. The evaluation is determined by, for example, a predetermined standard. A function evaluated as 0.0 indicates that the agent 200 does not have the function. The predetermined standard may be different for each function.

For example, human ability is determined to be 1.0 according to the predetermined standard related to autonomous traveling. At this time, a human can autonomously travel without selecting an area. In a case where the autonomous traveling speed of a certain robot is 80% of the moving speed of the human, and the area of the autonomously travelable area of the robot is 80% of the area of the autonomously travelable area of the human, the evaluation on the autonomous traveling of the robot is determined to be 1.0×0.8×0.8 according to the predetermined standard.

Furthermore, for example, the evaluation of the 50-inch 4K resolution display is set to 1.0, the 20 inch 2K resolution display is set to 0.8, and the like according to the predetermined standard regarding screen display. Note that, for example, the information management unit 112 may acquire each evaluation stored in the function evaluation table 126 by inputting the function list table 125 and the instruction to calculate the evaluation of each function of the agent 200 based on the function list table 125 to the LLM 300.

FIG. 6 is a diagram illustrating a data configuration example of the status information 123. The status information 123 indicates the current status, the current position, and the response completion prediction time of the agent 200 for each agent ID. Note that the status includes, for example, “response in progress”, “response preparation in progress”, “response possible”, “response impossible (failure)”, and the like.

The “response in progress” indicates a state in which the agent 200 currently responds to the user. The “response preparation in progress” indicates a state in which the agent 200 does not currently respond to the user but is scheduled to take over the response of the user from another agent 200. The “response possible” indicates a state in which the agent 200 can respond to the user. The “response impossible (failure)” indicates a state in which it is impossible to respond to the user due to the failure of the agent 200. Note that the response completion prediction time is stored in a record whose status is the “response in progress” or “response preparation in progress”.

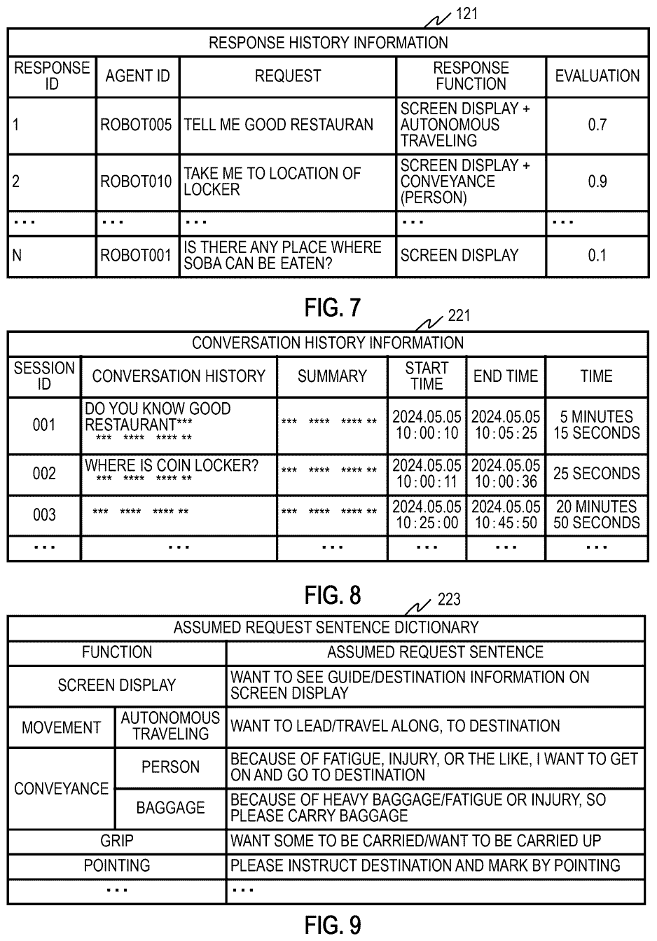

FIG. 7 is a diagram illustrating a data configuration example of the response history information 121. The response history information 121 indicates, for each response ID for identifying the response, the agent ID of the agent 200 that has performed the response, the request of the user estimated in the conversation in the response, the function (hereinafter, also referred to as a response function) provided by the agent 200 in the response, and the evaluation of the response from the user. Note that the individual response history information 222 held by each agent 200 indicates only information regarding the agent 200 in the response history information 121.

FIG. 8 is a diagram illustrating a data configuration example of the conversation history information 221. For example, the conversation history information 221 indicates, for each session ID for identifying a conversation, a conversation history (user's utterance and response to the utterance from the agent 200), a summary of the conversation, a start time of the conversation, an end time of the conversation, and a time from the start to the end of the conversation.

FIG. 9 is a diagram illustrating a data configuration example of the assumed request sentence dictionary 223. The assumed request sentence dictionary 223 indicates, for example, one or more assumed request sentences for each physical function of at least one agent 200 included in the conversation response system 10.

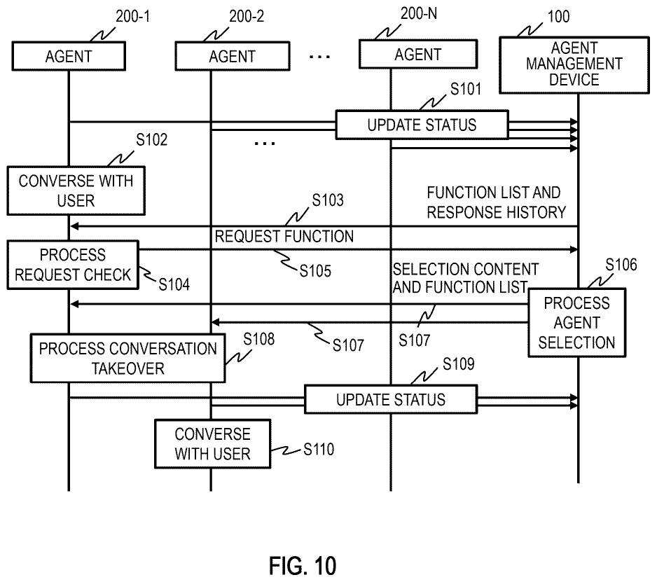

FIG. 10 is a sequence diagram illustrating an example of the conversation response processing. Here, in a case where the conversation response system 10 has N agents 200 and it is necessary to distinguish the agents 200 from each other, the N agents 200 are referred to as agents 200-1 to 200-N.

The status management unit 217 of each agent 200 specifies its own current status periodically or in response to a request from the agent management device 100, for example, and transmits information indicating the specified status to the agent management device 100, and the information management unit 112 of the agent management device 100 updates the status information 123 based on the received information (S101).

Note that the status management unit 217 specifies the current position of the agent 200, specifies the current status of the agent 200 according to the response status of the user, calculates the completion prediction time when the current status is the “response in progress” or the “response preparation in progress”, and includes the specified current position, the specified status, and the calculated completion time in the information indicating the status.

It is assumed that the conversation unit 211 of the agent 200-1 has started a conversation (included in response) with the user (S102). Note that the status management unit 217 of the agent 200-1 may notify the agent management device 100 of information indicating a status including that the status has changed to the “response in progress” at the timing when the response is started.

The request similarity calculation unit 213 of the agent 200-1 requests the agent management device 100 to transmit the function lists and the response histories of all the agents 200 included in the conversation response system 10, and the information management unit 112 of the agent management device 100 transmits the function information 122 and the response history information 121 to the agent 200-1 in response to the request (S103).

The agent 200-1 estimates a function that satisfies the user's request by executing the request check processing (S104). Details of the request check processing will be described later. The agent 200-1 notifies the agent management device 100 of the estimated function (S105).

The agent selection unit 111 of the agent management device 100 executes the agent selection processing to select the agent 200 that hands over the response performed by the agent 200-1 (S106). Details of the agent selection processing will be described later. Here, it is assumed that it is determined that the response is taken over from the agent 200-1 to the agent 200-2.

The agent selection unit 111 of the agent management device 100 extracts a function list of the agent 200-1 and the agent 200-2 from the function information 122, and transmits the extracted function list and information indicating the takeover source and the takeover destination agents 200 selected by the agent selection processing to the agent 200-1 and the agent 200-2 (S107).

The conversation takeover unit 216 of the agent 200-1 transmits the conversation (included in the conversation history information 221) currently being held with the user to the agent 200-2 which is the takeover destination, thereby taking over the conversation (response) from the agent 200-1 to the agent 200-2 (S108). The agent 200-2 continues a conversation with the user on the premise of the received conversation history.

Note that, in a case where the amount of conversation currently being held with the user is large (for example, the number of characters in the conversation is a predetermined value or more, or the time from the start of the conversation is a predetermined value or more), the conversation takeover unit 216 of the agent 200-1 may transmit the summary of the conversation, not the conversation itself currently being held with the user, to the agent 200-2 which is the takeover destination. Furthermore, the conversation unit 211 of the agent 200-1 may cause the user to understand that the response is taken over by outputting an utterance indicating that the response is taken over to the agent 200-2 via a speaker or the like.

The status management unit 217 of the agent 200-1 and the status management unit 217 of the agent 200-2 notify the agent management device 100 of information indicating the current own status according to the takeover result in Step S108, and the information management unit 112 of the agent management device 100 updates the status information 123 based on the received information (S109).

Specifically, for example, the status management unit 217 of the agent 200-1, which is the takeover source, notifies the agent management device 100 of information indicating a status including that the status becomes “response possible”, and the status management unit 217 of the agent 200-2, which is the takeover destination, notifies the agent management device 100 of information indicating a status including that the status becomes the “response in progress” or “response preparation in progress” and the response completion prediction time.

The conversation unit 211 of the agent 200-2 performs the conversation (included in response) with the user taken over from the agent 200-1 (S110).

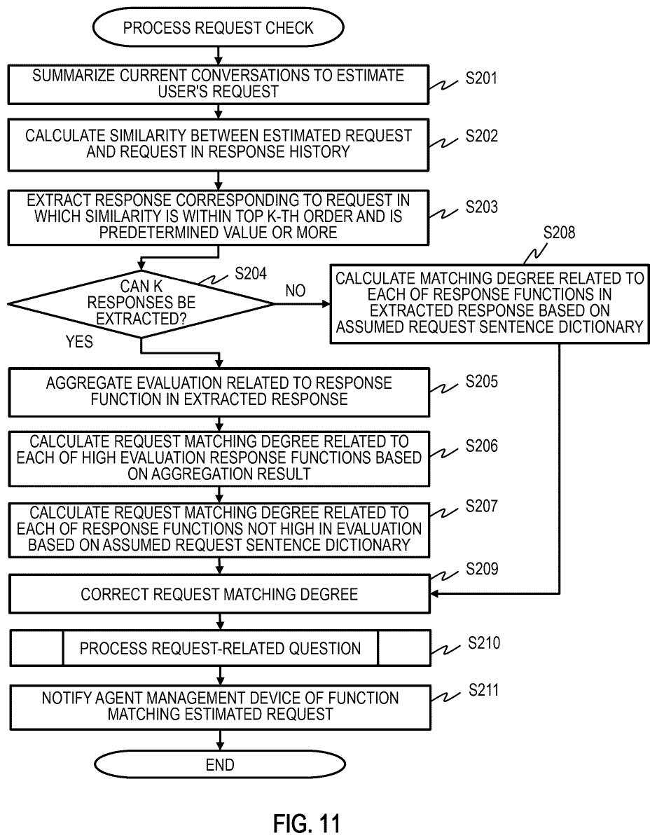

FIG. 11 is a flowchart illustrating an example of the request check processing in Step S104. The conversation summarizing unit 212 generates a prompt including the conversation with the user currently being held and a summary instruction (including the instruction to estimate the request of the user from the conversation) of the conversation, and inputs the prompt to the LLM 300 to acquire an estimated request of the user from the LLM 300 (S201).

The request similarity calculation unit 213 calculates similarity (for example, cosine similarity between requests converted into a vector indicating a meaning by a predetermined algorithm, or the like) between the request estimated in Step S201 and each request indicated by the response history information 121 transmitted from the agent management device 100 (S202).

The match degree calculation unit 214 extracts the response function and the evaluation in the response including the request in the response history information 121 in which the similarity calculated in Step S202 is within the top K-th order (K is a predetermined natural number) and is a predetermined value or more (S203).

The match degree calculation unit 214 determines whether K responses have been extracted in Step S203 (that is, whether there are K or more responses of which the similarity is the predetermined value or more) (S204). When it is determined in Step S204 that K responses have been extracted (S204: YES), the match degree calculation unit 214 aggregates the evaluations regarding the response functions in the responses extracted in Step S203 (S205).

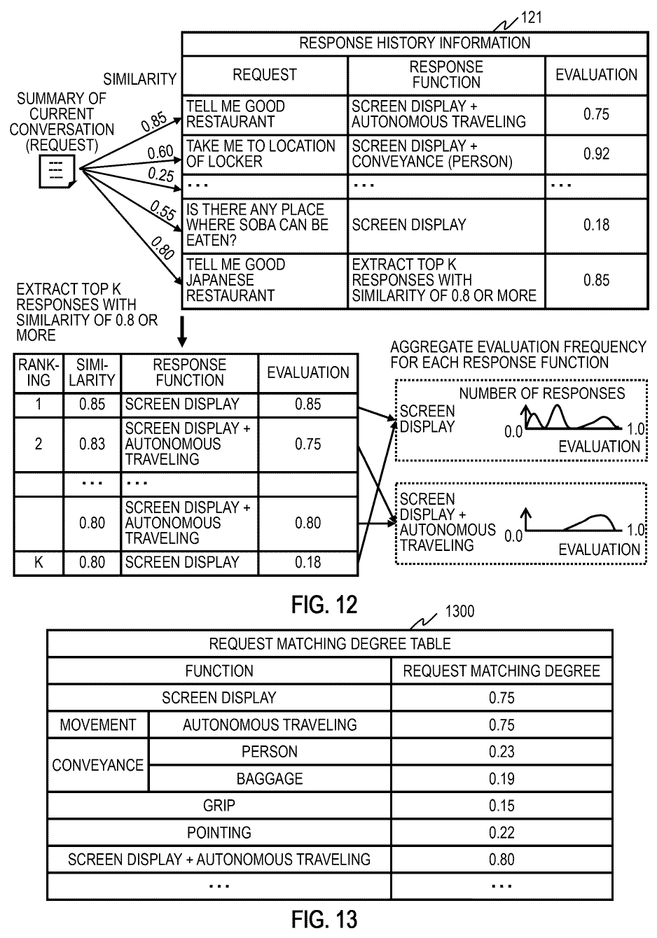

FIG. 12 is an explanatory diagram illustrating an example of similarity calculation processing, response extraction processing, and evaluation aggregation processing in Steps S202 to S205. In Step S202, the request similarity calculation unit 213 calculates the similarity between the request estimated from the current conversation and each request indicated by the response history information 121. In FIG. 12, the response ID and the agent ID are omitted from the information included in the response history information 121.

In Step S204, the match degree calculation unit 214 extracts the response function and the evaluation corresponding to the request of which the similarity is within the top K and is a predetermined value or more (here, it is assumed that the predetermined value is 0.8) in the response history information 121. Note that, in the example of FIG. 12, it is assumed that there are K or more responses with the similarity of 0.8 or more.

In Step S205, the match degree calculation unit 214 calculates an evaluation frequency (that is, the total number of responses in which each evaluation is recorded) for each of the response functions extracted in Step S203.

The description returns to FIG. 11. For each of the response functions having a high evaluation (for example, there are a predetermined number or more of responses evaluated as a predetermined value or more) aggregated in Step S205, the match degree calculation unit 214 calculates a request matching degree of the response function based on an aggregation result of the response functions (S206). Specifically, for example, the match degree calculation unit 214 calculates a value obtained by normalizing (the average of the evaluation of the response function)/(the variance of the evaluation of the response function) as the request matching degree of the response function.

In the example of FIG. 12 described above, while the evaluation of the response function “screen display” is widely distributed up to 0.0 to 1.0, the evaluation of the response function “screen display+autonomous traveling” is concentrated on 0.5 or more. In a case where the request matching degree is calculated by using the evaluation average itself as the request matching degree, even when the evaluation average of the “screen display” is high, the probability that a high evaluation can be obtained from the user is not high in the “screen display”. Therefore, as described above, the lower the variance, the higher the value of the request matching degree, so that high evaluation can be stably obtained from the user. As described above, in the example of FIG. 12, a higher request matching degree is obtained in the case of “screen display+autonomous traveling”.

Therefore, by the request matching degree calculation processing in Step S206, it is possible to specify a response function having a high possibility of stably obtaining a high evaluation among the past response functions for the request similar to the user's request.

For each of the response functions having a low evaluation (for example, there are less than a predetermined number of responses for evaluation equal to or greater than a predetermined value) aggregated in Step S205, the match degree calculation unit 214 calculates the request matching degree of the response function based on the assumed request sentence dictionary 223 (S207), and proceeds to Step S209.

A specific example of Step S207 will be described. For example, the match degree calculation unit 214 specifies an assumed request sentence corresponding to the response function in the assumed request sentence dictionary 223, calculates a similarity (for example, cosine similarity between an estimation request converted into a vector indicating a meaning by a predetermined algorithm and an assumed request sentence) between the request estimated in Step S201 and the assumed request sentence, and calculates a value obtained by normalizing the similarity (if the similarity is defined by a value of 0.0 or more and 1.0 or less, normalization is not necessary) as the request matching degree of the response function.

As indicated by assumed request sentence dictionary 223 in FIG. 9, for the function in which a plurality of assumed request sentences are defined, for example, match degree calculation unit 214 calculates a value obtained by normalizing the similarity with the request estimated in Step S201 for each of the plurality of assumed request sentences, and calculates a predetermined statistical value (for example, it may be an average value or a maximum value) of the calculated value as the matching degree of the response function.

Furthermore, for example, in a case where the calculation target of the request matching degree includes a plurality of response functions such as “screen display+autonomous traveling”, for example, the match degree calculation unit 214 calculates a value obtained by normalizing the similarity with the request estimated in Step S201 for the assumed request sentence corresponding to each of the plurality of response functions in the assumed request sentence dictionary 223, and calculates a predetermined statistical value (for example, it may be an average value or a maximum value) of the calculated value as the match degree of the plurality of response functions.

There is a possibility that the reliability of the aggregation result of the evaluation is not high, for example, the evaluation of a certain response function is unreasonably lowered because the agent 200 has responded to the user in the past, or the number of high evaluations of a certain response function by the agent 200 is not sufficient because the number of responses of the certain response function is not sufficient. Therefore, in Step S207, the match degree calculation unit 214 calculates the matching degree using the assumed request sentence dictionary 223 for the response function with a small number of highly evaluated responses, thereby increasing the possibility of more accurately evaluating the request matching degree.

When it is determined in Step S203 that the K responses have not been extracted (S204: NO), the match degree calculation unit 214 calculates the request matching degree of each of the response functions in the response extracted in Step S203 based on the assumed request sentence dictionary 223 in the same manner as in Step S207 (S208), and proceeds to Step S209.

Since the number of responses of a certain response function by the agent 200 is not sufficient, there is a possibility that the reliability of the aggregation result of the evaluation is not high, for example, the number of high evaluations of the response function is not sufficient. Therefore, in Step S208, when a sufficient number of responses cannot be extracted in Step S203, the match degree calculation unit 214 calculates the matching degree using the assumed request sentence dictionary 223 for each of the response functions, thereby increasing the possibility that the request matching degree can be more accurately evaluated.

The match degree calculation unit 214 corrects the calculated request matching degree (S209). Specifically, for example, the match degree calculation unit 214 multiplies the request matching degree calculated in Step S207 and the request matching degree calculated in Step S208 by a predetermined coefficient of 0 or more and less than 1.0. Note that, instead of the multiplication, the match degree calculation unit 214 may perform multiplication by multiplying the request matching degree calculated in Step S206 by a predetermined coefficient exceeding 1.0, or may perform both multiplications. As a result, the request matching degree calculated using the evaluation in the past response history can be emphasized rather than the request matching degree calculated using the assumed request sentence. Note that the processing of Step S209 may be omitted.

Note that the request matching degree may not be calculated using the assumed request sentence dictionary 223, and the request matching degree may be calculated for any of the corresponding functions based on the evaluation aggregation result. That is, the processing of Step S204, Step S207, Step S208, and Step S209 may be omitted.

The request-related question unit 215 and the conversation unit 211 execute the request-related question processing based on the request matching degree to specify a function matching the request estimated in Step S201 (S210). Details of the request-related question processing in Step S210 will be described later. The request-related question unit 215 notifies the agent management device 100 of the function specified in Step S210 (S211), and ends the request check processing.

FIG. 13 is a diagram illustrating a data configuration example of the request matching degree table 1300. The request matching degree table 1300 indicates the request matching degree (when the processing of Step S209 is omitted, the request matching degree calculated in Steps S206, S207, and S208) after the correction in Step S209 for each function. The request matching degree table 1300 may be stored in the auxiliary storage device 103 of the agent 200 that has performed the request check processing, or may be temporarily stored in the memory 102 of the agent 200.

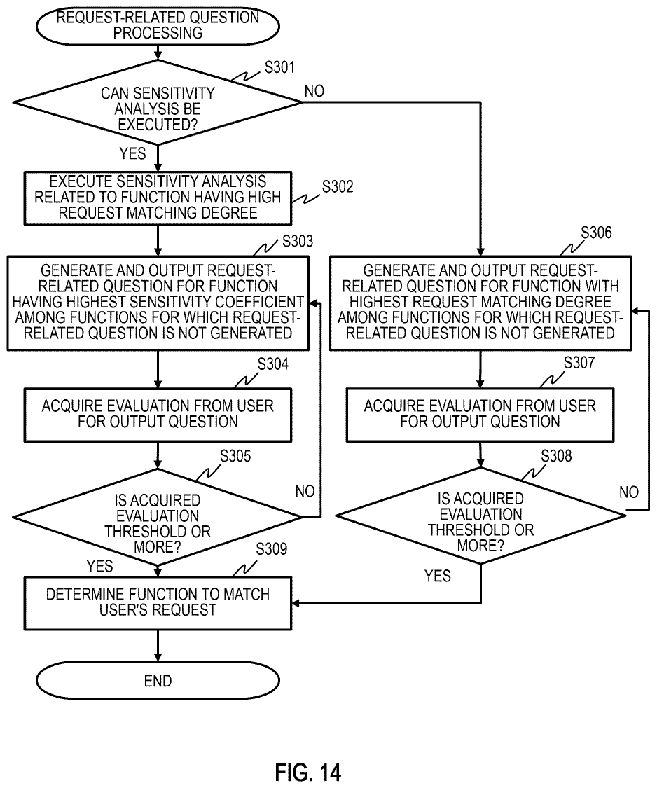

FIG. 14 is a flowchart illustrating an example of the request-related question processing in Step S210. The request-related question unit 215 determines whether the sensitivity analysis can be executed based on the number of responses extracted in Step S203 (S301). Specifically, for example, the request-related question unit 215 determines that the sensitivity analysis can be executed when the number of responses extracted in Step S203 is a predetermined value (for example, a value of K or less) or more, and determines that the sensitivity analysis cannot be executed when the number of responses extracted in Step S203 is less than the predetermined value (because accuracy of the sensitivity analysis is low).

When it is determined that the sensitivity analysis can be executed (S301: YES), the request-related question unit 215 calculates a sensitivity coefficient (an example of the degree of influence of the function on the evaluation from the user as a factor) of the function based on the evaluation indicated by the response history information 121 regarding the function, with respect to the sensitivity analysis regarding each function having a high request matching degree (for example, a predetermined value or more) indicated in the request matching degree table 1300 (S302).

Specifically, for example, when the evaluations of the five users for the “image display”, “autonomous traveling”, and “image display+autonomous traveling” are {0.8,0.5,0.7,0.2,0.6}, {0.7,0.8,0.6,0.7,0.9}, and {0.75,0.9,0.7,0.8,0.9}, respectively, the average evaluation points of “image display”, “autonomous traveling”, and “image display+autonomous traveling” are 0.56, 0.74, and 0.81, respectively. At this time, the request-related question unit 215 calculates the sensitivity coefficient of “image display” as 0.56/0.81=0.69, calculates the sensitivity coefficient of “autonomous traveling” as 0.74/0.81=0.91, and calculates the sensitivity coefficient of “image display+autonomous traveling” as 0.69+0.81=1.60 (it is assumed that the significant figure is 2 digits).

Further, the request-related question unit 215 may acquire the response history information 121 from the agent management device 100 in advance, calculate the sensitivity coefficient of each function using the response history information 121, convert the calculated sensitivity coefficient into a graph structure, and store the graph structure in the memory 102 or the auxiliary storage device 103 of the agent 200.

Specifically, for example, the request-related question unit 215 clusters (for example, a cluster including a request having a similarity of a predetermined value or more is generated (one request may belong to a plurality of clusters)) the requests based on the similarity (for example, a cosine similarity between requests converted by a predetermined algorithm into a vector indicating a meaning) between the requests indicated by the response history information 121, performs sensitivity analysis of the functions included in the cluster for each cluster, and converts the result of the sensitivity analysis into a graph structure for each cluster. As a result, the request-related question unit 215 can quickly determine which function has a higher sensitivity coefficient in response to the request estimated in Step S201, that is, can reduce the amount of calculation in real time, so that the response to the user is quick.

The request-related question unit 215 acquires a request-related question related to a function by inputting a prompt including information indicating the function having the highest sensitivity coefficient calculated in Step S302 among the functions for which the request-related question is not generated and an instruction to generate a request-related question related to the function to the LLM 300, and the conversation unit 211 outputs the request-related question from a speaker or the like (S303).

For example, a question such as “Would you like the system to lead you to the destination in parallel?” or “When it is an unfamiliar place, shall we lead the way to the front of the store?” is generated as the request-related question regarding the “autonomous traveling”. Furthermore, for example, a question such as “Since the surroundings are vacant now, you can get on without worrying about the surroundings and get on to the destination. Would you like to get on? It is easy.” is generated as the request-related question regarding “conveyance (person)”.

As in the above-described example, the request-related question is desirably a question that elicits an answer from the user while indirectly (implicitly) recommending a function to the user. Therefore, the instruction to generate the request-related question included in the prompt desirably includes an instruction indicating to indirectly ask whether the function is a good choice for the user.

The conversation unit 211 acquires the answer from the user to the request-related question generated in Step S303 from the microphone or the like, and the request-related question unit 215 acquires the evaluation for the function indicated by the request-related question from the LLM 300 by inputting the prompt including the answer from the user and an instruction to calculate the evaluation from the user for the function indicated by the request-related question based on the answer to the LLM 300 (S304). Note that the evaluation for the function may be answered by a specific value from the user, and in this case, the request-related question unit 215 acquires the specific value as the evaluation without using the LLM 300.

The request-related question unit 215 determines whether the evaluation acquired in Step S304 is a predetermined threshold or more (S305). In a case where it is determined that the evaluation acquired in Step S304 is the predetermined threshold or more (S305: YES), the request-related question unit 215 proceeds to Step S309. In a case where it is determined that the evaluation acquired in Step S304 is less than the predetermined threshold (S305: NO), the request-related question unit 215 returns to Step S303.

When it is determined that the sensitivity analysis cannot be executed (S301: NO), the request-related question unit 215 acquires the request-related question related to the function having the highest request matching degree among the functions for which the request-related question is not generated by a method similar to Step S303, and the conversation unit 211 outputs the request-related question from a speaker or the like (S306).

The conversation unit 211 acquires the answer from the user to the request-related question generated in Step S307 from a microphone or the like, and the request-related question unit 215 acquires the evaluation of the function from the user by the method similar to Step S304 (S307).

The request-related question unit 215 determines whether the evaluation acquired in Step S307 is the predetermined threshold or more (S308). In a case where it is determined that the evaluation acquired in Step S307 is the predetermined threshold or more (S308: YES), the request-related question unit 215 proceeds to Step S309. In a case where it is determined that the evaluation acquired in Step S307 is less than the predetermined threshold (S308: NO), the request-related question unit 215 returns to Step S306.

The request-related question unit 215 determines the function for which the evaluation determined to be the predetermined threshold or more in Step S305 or Step S308 is obtained as a function matching the request of the user, notifies the agent management device 100 of the determined function (S309), and ends the request-related question processing.

Note that, for example, in a case where it is determined in Step S305 or Step S308 that the evaluation is less than the predetermined threshold, or in a case where it is determined in Step S305 or Step S308 that the evaluation is unknown (in Step S304 or Step S307, the answer from the user has not been obtained (for example, no answer or no reaction)), the request-related question unit 215 may input a prompt including an instruction to generate an additional question regarding a function according to the intention by estimating the intention of the user based on the answer from the user obtained in Step S304 or Step S307 to the LLM 300, acquire the additional question, and the conversation unit 211 may output the additional question from the speaker or the like of the agent 200.

Specifically, for example, in a case where the answer from the user is “Since this is the first time I come here, it is difficult to understand, but I will look for it.” or the like indicating that the user cannot clearly image the destination, “We want to talk with you, so shall we walk to the destination while talking a little?” or the like is generated as the additional question, and the agent 200 may indirectly lead the user.

Furthermore, for example, in a case where the answer from the user is “shameful” or the like, a proposal of contrivance for avoiding “If you pretend not to be with me while passing through an inconspicuous route, you can get to the destination without getting lost.” embarrassment is made as the additional question.

Furthermore, for example, in a case where the answer from the user cannot be obtained, it may be assumed that the user has not listened to or could not understand the request-related question, and the request-related question may be performed again or a question in which the request-related question is changed to a plainer expression may be performed as the additional question.

For example, the conversation unit 211 may acquire answers to these additional questions from the user, and the request-related question unit 215 may acquire an evaluation of the user for the acquired answer using the LLM 300, store a combination of the answer to the request-related question from the user and the new question from which the answer with a high evaluation (for example, the predetermined value or more) has been acquired as a dictionary, and use the dictionary for the next or subsequent request question processing.

In addition, for example, in a case where it is determined in Step S305 or Step S308 that the evaluation is less than the predetermined threshold, the request-related question unit 215 may input a prompt including an instruction to determine whether a proposal related to another function is included in the answer from the user obtained in Step S304 or Step S307 into the LLM 300, and acquire the output from the LLM 300.

In a case where the output result indicating that the answer from the user includes the proposal related to another function is acquired, when the evaluation (for example, the average of the evaluations) of “currently selected function+the other function” indicated by the response history information 121 is high, the request-related question unit 215 may acquire the additional question by inputting a prompt including an instruction to generate an additional question for proposing “currently selected function+the other function” into the LLM 300, and the conversation unit 211 may output the additional question from the speaker or the like of the agent 200. When the evaluation (generated using the LLM 300) indicated by the answer from the user to the additional question is high, the “currently selected function+the other function” is determined as a function matching the user's request in Step S309.

Furthermore, in a case where the request-related question unit 215 acquires the output result indicating that the proposal related to another function is included in the answer from the user, the request-related question unit may acquire the additional question by inputting, to the LLM 300, a prompt including an instruction to generate an additional question for asking a degree to which the user's request is satisfied by “currently selected function+the other function”, and the conversation unit 211 may output the additional question from the speaker or the like of the agent 200. When the evaluation (generated using the LLM 300) indicated by the answer from the user to the additional question is high, the “currently selected function+the other function” is determined as a function matching the user's request in Step S309.

Note that, in the request-related question processing, the processing (that is, the processing of Steps S301 to S305) related to the sensitivity analysis may not be executed, and in this case, the request-related question related to the function may be simply generated in descending order of the matching degree.

In the question generation processing described above, in Step S303 or Step S306, the request-related question is generated in order from the function having the high sensitivity coefficient or the high matching degree, and the function having the high evaluation from the user is selected, and thus, the function that follows the user's request with high probability can be selected with a small number of questions.

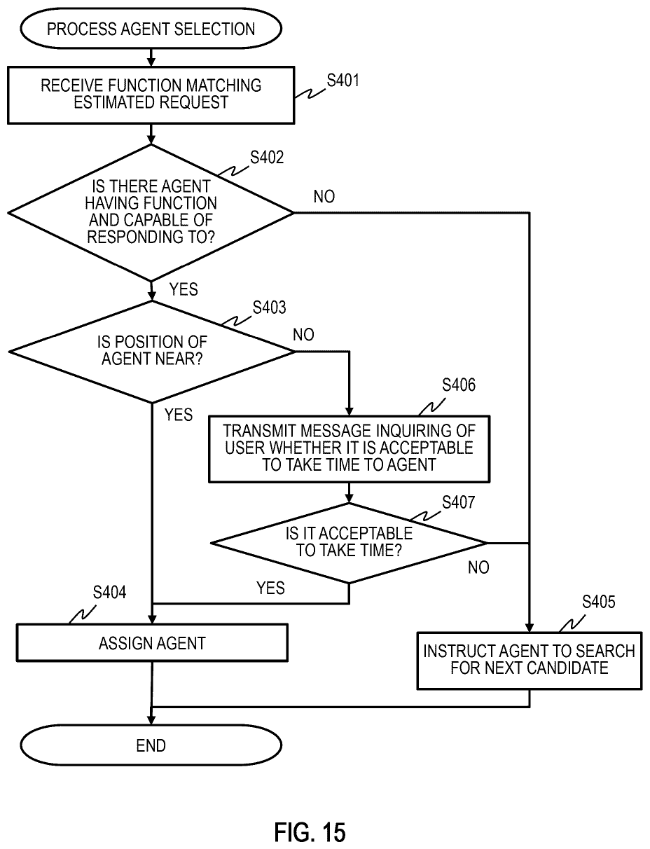

FIG. 15 is a flowchart illustrating an example of the agent selection processing. The agent selection unit 111 of the agent management device 100 receives a function matching the user's estimated request transmitted in Step S309 (S401).

The agent selection unit 111 refers to the function information 122 to specify an agent 200 having a function matching the estimated request among the specified agents 200, and refers to the status information 123 to determine whether there is an agent 200 whose status is “possible for response” among the specified agents 200 (S402).

Note that, for example, the agent selection unit 111 specifies the agent 200 in which the evaluation of the estimated function indicated by the function evaluation table 126 included in the function information 122 is a predetermined value or more as the agent 200 having the function matching the estimated request.

When it is determined that there is the agent 200 that has a function matching the estimated request and is capable of responding to (S402: YES), the agent selection unit 111 refers to the status information 123 and determines whether there is an agent 200 located close to the agent 200 currently responding to the user among the agents 200 (S403).

Note that, for example, in a case where the distance between the agents 200 is within a predetermined value, the agent selection unit 111 determines that the position between the agents 200 is close. Furthermore, when the distance (for example, a value obtained by subtracting a value obtained by multiplying the moving speed of each agent 200 by a predetermined coefficient from the distance between the agents 200) between the agents 200 in consideration of the moving speed (for example, the highest speed among autonomous traveling and driving) of each of the agents 200 indicated by the function list table 125 is within a predetermined value, the agent selection unit 111 may determine that the position between the agents 200 is close.

When it is determined that there is an agent 200 located close to the agent 200 currently responding to the user among the agents selected in Step S402 (S403: YES), the agent selection unit 111 allocates the agent 200 located close to the takeover destination agent 200 of the response, executes the processing of Step S107 (S404), and ends the agent selection processing.

In a case where it is determined that there is no agent 200 having a function matching the estimated request and capable of responding to (S402: NO), the agent selection unit 111 instructs the agent 200 that has transmitted the estimated request to search for the next candidate (S405), and ends the agent selection processing. Note that the agent 200 instructed to search for the next candidate returns to the request-related question processing. Specifically, for example, in a case where the number of responses extracted in Step S203 is a predetermined value (for example, a value of K or less) or more (specifically, for example, in a case where it is determined that the sensitivity analysis can be performed in Step S301), the agent 200 instructed to search for a candidate executes the processing in and after Step S303 again, and in a case where the number of responses extracted in Step S203 is less than the predetermined value (specifically, for example, in a case where it is determined in Step S301 that the sensitivity analysis cannot be performed), the agent executes the processing in and after Step S306 again.

When it is determined that there is no agent 200 located close to the agent 200 currently responding to the user among the agents selected in Step S402 (S403: NO), the agent selection unit 111 transmits the message inquiring of the user whether it is acceptable to take time to the agent 200 that has transmitted the estimated request (S406). The conversation unit 211 of the agent 200 outputs the message from the speaker or the like of the agent 200, acquires the answer (for example, the alternative of “Yes” or “No”) of the user to the message from the microphone or the like of the agent 200, and transmits the answer to the agent management device 100.

The agent selection unit 111 refers to the answer to the message and determines whether the user can accept that it takes time (S407). In a case where it is determined that the user can accept that it takes time (S407: YES), the agent selection unit 111 proceeds to Step S404, and allocates the agent 200 (among the agents 200 that satisfy the condition of step S402, it is desirable that the agent 200 be the one that is closest in distance (which may take into account the moving speed) to the takeover source agent 200) satisfying the condition of Step S402 as the takeover destination agent 200. In a case where it is determined that the user cannot accept that it takes time (S407: NO), the agent selection unit 111 proceeds to Step S405.

Note that, in a case where the plurality of agents 200 satisfies Step S403 (the condition of Step S402 in a case where the condition of Step S407 is satisfied), the agent selection unit 111 allocates the plurality of agents 200 as the takeover destination agent 200, for example. As a result, when at least one of the responses by the plurality of agents 200 meets the request of the user, high evaluation can be obtained from the user.

Furthermore, in a case where the plurality of agents 200 satisfies the condition of Step S403 or Step S405, the agent selection unit 111 may allocate, for example, an agent having the highest weighted average of the evaluation of the estimated function and the distance between the agents 200 (may be a distance in consideration of the moving speed) among the plurality of agents 200 as the takeover destination agent 200. As a result, among the plurality of agents 200, the agent 200 that is highly likely to be highly evaluated by the user and can quickly respond to the user is selected.

Furthermore, in a case where the agent selection unit 111 refers to the function information 122 and determines that neither the takeover destination agent 200 nor the takeover source agent 200 can move, it is desirable that the agent selection unit notify the position indicated by the status information 123 of the takeover destination agent 200 to the takeover source agent 200 and cause the conversation unit 211 of the takeover source agent 200 to output an utterance prompting the user to move to the position of the takeover destination agent 200 from the speaker of the takeover source agent 200.

Note that, in a case where the agent 200 assigned in Step S404 is the same as the agent 200 currently having a conversation with the user, it is preferable that the agent 200 in response is not changed and continues to perform response to the user without performing the processing in and after Step S108.

With the agent selection processing described above, the agent selection unit 111 can select the agent 200 that has a function of satisfying the request of the user and can quickly take over the response. Furthermore, for the user who can accept that it takes time, the agent selection unit 111 can select the agent 200 having a function of satisfying the request of the user after making the user understand that it takes time.

Note that the conversation response system 10 may not include the agent 200, and the agent management device 100 may include various functional units and various types of information (in addition, various drive mechanisms) included in the agent 200. At this time, the agent management device 100 may estimate a function matching the request of the user by executing the processing of Steps S102 to S104 (the estimated function may be provided when the agent management device has a drive mechanism).

### Second Embodiment

A second embodiment is different from the first embodiment in the agent selection processing in Step S210. In the second embodiment, differences from the first embodiment will be mainly described, and description of the same points as those of the first embodiment will be omitted as appropriate.

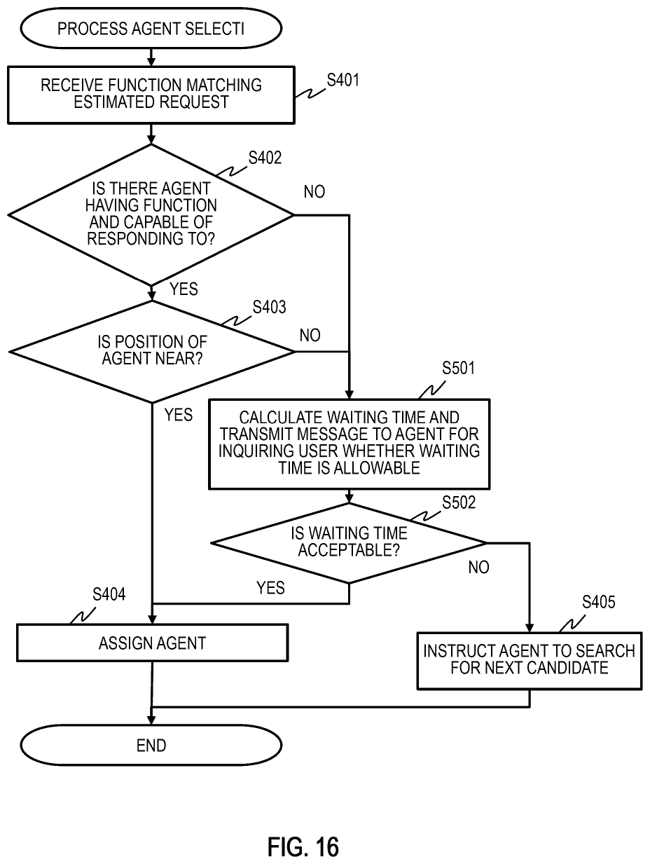

FIG. 16 is a flowchart illustrating an example of the agent selection processing. In a case where it is determined that there is no agent 200 having a function matching the estimated request and capable of responding to (S402: NO), the agent selection unit 111 proceeds to Step S501. When it is determined that there is no agent 200 located close to the agent 200 currently responding to the user among the agents selected in Step S402 (S403: NO), the agent selection unit 111 proceeds to Step S501.

The agent selection unit 111 calculates a waiting time of the user until taking over the response, and transmits the message inquiring of the user whether the calculated waiting time is acceptable to the agent 200 that has transmitted the estimated request (S501). A specific example of a method of calculating the waiting time will be described later. The conversation unit 211 of the agent 200 outputs the message from the speaker or the like of the agent 200, acquires the answer (for example, the alternative of “Yes” or “No”) of the user to the message from the microphone or the like of the agent 200, and transmits the answer to the agent management device 100.

The agent selection unit 111 refers to the answer to the message and determines whether the user can accept the waiting time (S502). When it is determined that the user can accept the waiting time (S502: YES), the agent selection unit 111 proceeds to Step S404.

In Step S404 transitioning from Step S502, when there is the agent 200 satisfying the condition of Step S402, the agent selection unit 111 allocates the agent 200 (among the agents 200 that satisfy the condition of step S402, it is desirable that the agent 200 be the one that is closest in distance (which may take into account the moving speed) to the takeover source agent 200) satisfying the condition of Step S402 as the takeover destination agent 200, and when there is no agent 200 satisfying the condition of Step S402, the agent selection unit 111 allocates the agent 200 (among the agents 200 having the function matching the estimated request, it is desirable that the agent 200 be the one that is closest in distance (which may take into account the moving speed) to the takeover source agent 200) having the function matching the estimated request as the takeover destination agent 200.

In a case where it is determined that the user cannot accept the waiting time (S502: NO), the agent selection unit 111 proceeds to Step S405.

A specific example of a method of calculating the waiting time will be described. The agent selection unit 111 requests the agent 200 that has transmitted the estimated request to transmit the conversation history information 221 and the summary of the current conversation. The agent selection unit 111 calculates similarity (for example, cosine similarity between summaries converted into a vector indicating a meaning by a predetermined algorithm, or the like) between each summary of the past conversation indicated by the conversation history information 221 and the summary of the current conversation.

The agent selection unit 111 extracts the time corresponding to the summary of the past conversation having a similarity to the current conversation of a predetermined value or more (for example, 0.8 or more) in the conversation history information 221, and calculates an average of the extracted times as the waiting time.

Furthermore, the agent selection unit 111 may correct the waiting time. Specifically, for example, the agent selection unit 111 requests the agent 200 to transmit a reaction time from the end of each utterance of the agent 200 in the current conversation to the response of the user to the conversation. In a case where the average of the reaction times is a predetermined time or more, the agent selection unit 111 extracts the number of remarks of the user in the conversation history in the conversation history information 221 corresponding to the summary of the past conversation in which the similarity with the current conversation is a predetermined value or more (for example, 0.8 or more), adds a value obtained by multiplying a value obtained by subtracting the predetermined time from the average of the reaction times and the average of the number of remarks to the time indicated by the conversation history information 221, and calculates the average of the times corresponding to the summary of the past conversation in which the similarity with the current conversation is the predetermined value or more in the conversation history information 221 as the waiting time.

Furthermore, for example, the agent selection unit 111 requests the agent 200 to transmit an index value (for example, the duration of the current conversation or the volume of the user's utterance in the current conversation) indicating the excitement of the current conversation. In a case where the index value indicating the excitement of the current conversation is a predetermined value or more, the agent selection unit 111 calculates, as the waiting time, a value obtained by multiplying the average of the times corresponding to the summary of the past conversation, the similarity of which with the current conversation is a predetermined value or more, in the conversation history information 221 by a predetermined coefficient (for example, a value of 1.0 or more).

Furthermore, for example, the agent selection unit 111 specifies the function of the agent 200 currently responding from the function information 122, and calculates, as the waiting time, a value obtained by adding an estimated operation time by the specified function to an average of times corresponding in the conversation history information 221 to a summary of a past conversation having a similarity with the current conversation of a predetermined value or more. The estimated operation time by the function is determined in advance for each function, for example.

With the agent selection processing of the second embodiment, the agent selection unit 111 can select the agent 200 that has the function of satisfying the request of the user and can quickly take over the response. Furthermore, the agent selection unit 111 can cause the user to understand that a waiting time is required for the user who can accept the waiting time, and then select the agent 200 having the function of satisfying the request of the user.

### Third Embodiment

In a third embodiment, the conversation takeover processing in Step S108 and the conversation after the takeover in Step S109 are different from those of the first embodiment. In the third embodiment, differences from the first embodiment will be mainly described, and description of the same points as those of the first embodiment will be omitted as appropriate.

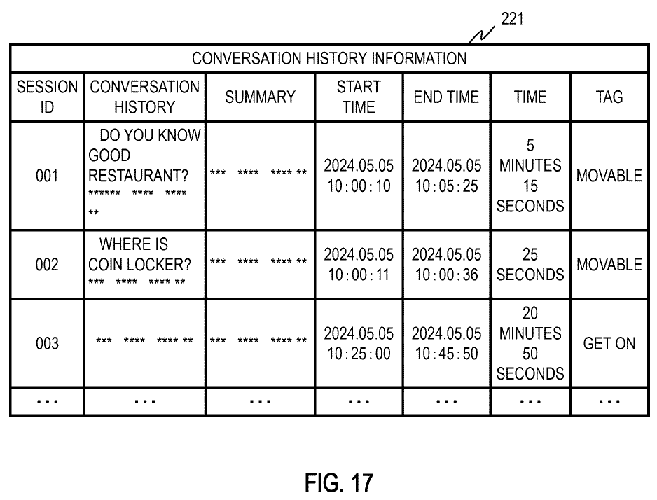

FIG. 17 is a diagram illustrating a data configuration example of the conversation history information 221. The conversation history information 221 in third embodiment is different from the conversation history information 221 in the first embodiment in further indicating a tag.

As described above, in Step S107, the function list included in each of a takeover source agent 200-1 and a takeover destination agent 200-2 with respect to the takeover source agent 200-1 is transmitted from the agent selection unit 111 to the agent management device 100.

In Step S108, the takeover source agent 200-1 refers to the function list received in Step S107, adds a tag indicating a function included in the takeover source agent 200-1 and not included in the takeover destination agent 200-2, and then hands over the conversation with the user currently being held to the agent 200-2. The takeover source agent 200-1 stores the added tag in the conversation history information 221.

Note that the takeover source agent 200-1 may input, to the LLM 300, a conversation history with the currently performed user, the function list received in Step S107, and an instruction to extract, from the function list, a function suggested in the conversation history, which is the function included in the takeover source agent 200-1 and not included in the takeover destination agent 200-2, and add the function extracted by the LLM 300 as a tag. As a result, only the function specialized for the takeover source agent 200-1, which is the function related to the conversation currently being performed, is added as the tag.

In Step S109, the conversation unit 211 of the takeover destination agent 200-2 includes an instruction to generate an utterance (response to the utterance of the user) of a content (on the assumption that the function cannot be executed) corresponding to the fact that the agent 200-2 cannot execute the function indicated by the tag received from the takeover source agent 200-1 in the prompt input to the LLM 300 when having a conversation with the user.

For example, it is assumed that the following conversation is performed between the movable takeover source agent 200-1 and the user, and the subsequent response is taken over by the agent 200-2 that cannot move.

### Conversation between Agent 200-1 and User

User: “Please recommend a restaurant nearby.”

Agent 200-1: “The recommended restaurant nearby is restaurant A. The restaurant A also has good reviews.”

User: “This is my first time here, so please lead the way.”

Agent 200-1: “I will lead the way, so please follow me carefully.”

In this case, the agent 200-1 adds a tag “movable” indicating a function included in the agent 200-1 and not included in the agent 200-2 to the conversation, and transmits the conversation history to the agent 200-2.

As a result, in the conversation after taking over, the agent 200-2 can make the utterances that assume that the agent 200-2 does not have the function of moving. That is, it is possible to prevent the agent 200-2 from making an utterance on the premise of movement even though the agent cannot move.

In the processing described above, the conversation response system 10 of the third embodiment can take over the conversation according to the function in consideration of the function of the takeover source agent 200-1 and the takeover destination agent 200-2.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A conversation response system, comprising:
a processor; a memory; an input device; and an output device,
the conversation response system being connected to a language model,
the memory being configured to hold:
function information indicating a function that can be provided by the conversation response system; and
response history information indicating a request of a user indicated by a history of a past conversation between the conversation response system and the user, a response function which is the function provided in the conversation, and evaluation by the user for a response including the conversation and provision of the response function, and
the processor being configured to:
execute a conversation with the user by generating a first prompt including an instruction to generate a response to an utterance of the user acquired via the input device, inputting the first prompt to the language model, and outputting a response output from the language model based on the input to the output device;
summarize the conversation to estimate the request of the user;
aggregate a distribution of corresponding evaluations in the response history information with respect to the response function included in the response history information;
calculate a request matching degree indicating a degree of satisfaction of the estimated request by the response function included in the response history information based on an aggregation result of the distribution;
execute request-related question processing for the response function included in the response history information in descending order of the evaluation indicated by the request matching degree;
in the request-related question processing,
generate a second prompt including an instruction to generate a question about whether the request of the user is satisfied by the response function;
input the second prompt to the language model;
output, from the output device, a question output from the language model based on the input; and
determine the response function as a function that satisfies a request of the user and terminate the request-related question processing, when an answer to the question is obtained from the user via the input device and an evaluation of the obtained answer is a predetermined value or more.

2. The conversation response system according to claim 1, wherein the processor is configured to:
calculate a similarity between the estimated request and a request indicated by the response history information;
extract, from the response history information, a response function corresponding to a request having a high similarity based on a predetermined first condition;
aggregate the distribution of the corresponding evaluation in the response history information for each of the extracted response functions;
calculate the request matching degree of each of the extracted response functions based on the aggregation result of the distribution; and
execute the request-related question processing for each of the extracted response functions in descending order of the evaluation indicated by the request matching degree.

3. The conversation response system according to claim 1, wherein the processor is configured to calculate the request matching degree with respect to the response function so as to be larger as an average of the evaluations indicated by the distribution is larger and so as to be smaller as a variance of the evaluations indicated by the distribution is larger.

4. The conversation response system according to claim 1, wherein the memory is configured to hold a dictionary indicating the functions and an assumed request sentence that is a sentence assumed as an utterance from the user when provision of each of the functions is requested, and
wherein the processor is configured to:
calculate the request matching degree based on the aggregation result of the distribution for each of the response functions whose evaluation indicated by the aggregation result of the distribution is high based on a predetermined second condition; and
calculate, for each of the response functions whose evaluation indicated by the aggregation result of the distribution is low based on the second condition, the request matching degree based on a similarity between the estimated request and the assumed request sentence corresponding to the response function in the dictionary.

5. The conversation response system according to claim 4, wherein the processor is configured to execute at least one of:
a correction of performing a predetermined calculation on the request matching degree calculated based on the aggregation result of the distribution to increase the request matching degree; and
a correction of performing a predetermined calculation on the request matching degree calculated based on a similarity between the estimated request and the assumed request sentence corresponding to the response function in the dictionary to reduce the request matching degree.

6. The conversation response system according to claim 1, wherein the processor is configured to:
calculate an influence of the response function on the evaluation by the user as a factor based on the distribution of the response function included in the response history information; and
execute the request-related question processing for the response function included in the response history information according to an order based on the calculated influence.

7. The conversation response system according to claim 1, further comprising a plurality of agents,
wherein each of the plurality of agents is configured to:
include the input device and the output device and is connected to the language model; and
execute the conversation with the user by generating the first prompt, inputting the first prompt to the language model, and outputting a response output from the language model based on the input to the output device,
wherein the function information indicates a function that can be provided by each of the plurality of agents, and
wherein the memory is configured to hold status information indicating a status indicating whether each of the plurality of agents is capable of responding to the user and a position of each of the plurality of agents, and
wherein the processor is configured to:
determine, from the plurality of agents, a takeover destination agent that hands over the response performed on the user from a takeover source agent based on the possibility of providing the function satisfying the request indicated by the function information, the status indicated by the status information, and the position indicated by the status information for each of the plurality of agents; and
transmit information indicating a conversation included in the response performed on the user to the takeover destination agent.

8. The conversation response system according to claim 7, wherein the processor is configured to:
when it is determined with reference to the function information and the status information that there is an agent that has a function of satisfying the request and is capable of responding to the user, but it is determined that a distance between the agent and an agent currently having a conversation with the user is not close based on a predetermined third condition,
generate a message inquiring the user whether it is acceptable to take time and outputs the message from the output device,
acquire an answer from the user to the message via the input device and acquires an evaluation of the answer to the message,
determine the agent that has a function of satisfying the request and is determined to be an agent capable of responding to the user as the takeover destination agent, in a case where it is determined that the evaluation for the answer to the message is high based on a predetermined fourth condition, and
execute the request-related question processing again when it is determined that the evaluation for the answer to the message is low based on the fourth condition.

9. The conversation response system according to claim 7, wherein the memory is configured to hold conversation history information indicating a summary of a conversation in the past conversation history and a conversation time in the past conversation history, and
wherein the processor is configured to:
when it is determined with reference to the function information and the status information that there is an agent that has a function of satisfying the request and is capable of responding to the user, but it is determined that a distance between the agent and an agent currently having a conversation with the user is not close based on a predetermined third condition,
calculate a waiting time for taking over the response performed on the user from the takeover source agent to the takeover destination agent based on the conversation time in a history of the past conversation in which similarity between a summary of the conversation currently performed with the user and a summary indicated by the conversation history information is a predetermined value or more;
generate a message inquiring the user whether the waiting time is acceptable and outputs the message from the output device;
acquire an answer from the user to the message via the input device and acquires an evaluation of the answer to the message;
determine the agent that has a function of satisfying the request and is determined to be an agent capable of responding to the user as the takeover destination agent, in a case where it is determined that the evaluation for the answer to the message is high based on a predetermined fourth condition; and
execute the request-related question processing again when it is determined that the evaluation for the answer to the message is low based on the fourth condition.

10. The conversation response system according to claim 7, wherein the processor is configured to:
specify a function that can be provided by the takeover source agent and cannot be provided by takeover destination agent with reference to the function information; and
include a tag indicating the specified function in information indicating a conversation included in the response performed on the user, and
wherein the takeover destination agent includes, as a response to the utterance of the user, an instruction to generate a response having contents on an assumption that the function indicated by the tag cannot be executed by the takeover destination agent in the first prompt, inputs the first prompt to the language model, and outputs a response output from the language model based on the input to the output device, thereby executing the conversation with the user taken over from the takeover source agent.

11. A conversation response method by a conversation response system,
the conversation response system:
including a processor, a memory, an input device, and an output device; and
being connected to a language model,
the memory being configured to hold:
function information indicating a function that can be provided by the conversation response system; and
response history information indicating a request of a user indicated by a history of a past conversation between the conversation response system and the user, a response function which is the function provided in the conversation, and evaluation by the user for a response including the conversation and provision of the response function, and
the conversation response method comprising:
executing, by the processor, a conversation with the user by generating a first prompt including an instruction to generate a response to an utterance of the user acquired via the input device, inputting the first prompt to the language model, and outputting a response output from the language model based on the input to the output device;
summarizing, by the processor, the conversation to estimate the request of the user;
aggregating, by the processor, a distribution of corresponding evaluations in the response history information with respect to the response function included in the response history information;
calculating, by the processor, a request matching degree indicating a degree of satisfaction of the estimated request by the response function included in the response history information based on an aggregation result of the distribution;
executing, by the processor, request-related question processing for the response function included in the response history information in descending order of the evaluation indicated by the request matching degree;
in the request-related question processing,
generating, by the processor, a second prompt including an instruction to generate a question about whether the request of the user is satisfied by the response function;
inputting, by the processor, the second prompt to the language model;
outputting, by the processor, from the output device, a question output from the language model based on the input; and
determining, by the processor, the response function as a function that satisfies a request of the user and terminate the request-related question processing, when an answer to the question is obtained from the user via the input device and an evaluation of the obtained answer is a predetermined value or more.

12. A non-transitory recording medium storing a conversation response program for causing a conversation response system to execute conversation response processing,
the conversation response system:
including a processor, a memory, an input device, and an output device; and
being connected to a language model,
the memory being configured to hold:
function information indicating a function that can be provided by the conversation response system; and
response history information indicating a request of a user indicated by a history of a past conversation between the conversation response system and the user, a response function which is the function provided in the conversation, and evaluation by the user for a response including the conversation and provision of the response function, and
the conversation response program causing the processor to execute processing comprising:
executing a conversation with the user by generating a first prompt including an instruction to generate a response to an utterance of the user acquired via the input device, inputting the first prompt to the language model, and outputting a response output from the language model based on the input to the output device;
summarizing the conversation to estimate the request of the user;
aggregating a distribution of corresponding evaluations in the response history information with respect to the response function included in the response history information;
calculating a request matching degree indicating a degree of satisfaction of the estimated request by the response function included in the response history information based on an aggregation result of the distribution; and
executing request-related question processing for the response function included in the response history information in descending order of the evaluation indicated by the request matching degree;
in the request-related question processing,
generating a second prompt including an instruction to generate a question about whether the request of the user is satisfied by the response function;
inputting the second prompt to the language model;
outputting, from the output device, a question output from the language model based on the input; and
determining the response function as a function that satisfies a request of the user and terminate the request-related question processing, when an answer to the question is obtained from the user via the input device and an evaluation of the obtained answer is a predetermined value or more.
